(19) United States
(12) Patent Application Publication
(10) Pub. No.: US 2026/0072390 A1
(43) Pub. Date: Mar. 12, 2026

(54) IMAGE FORMING APPARATUS, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Mitsunori SHIOI, Kanagawa (JP); Yuichi NISHIKUNI, Kanagawa (JP); Tatsuya NAMIKI, Kanagawa (JP); Chihiro MATSUGUMA, Kanagawa (JP)

(73) Assignee: FUJIFILM Business Innovation Corp., Tokyo (JP)

(21) Appl. No.: 19/048,989

(22) Filed: Feb. 10, 2025

(30) Foreign Application Priority Data
Sep. 10, 2024 (JP) 2024-155452

(51) Int. Cl. G03G 15/00; G03G 15/01; G03G 15/16

(52) U.S. Cl. CPC G03G 15/6567; G03G 15/0131; G03G 15/1605; G03G 2215/0141; G03G 2215/0161

(57) ABSTRACT

An image forming apparatus includes: a first image forming unit that has a plurality of image forming sections and an intermediate transfer body to which toner images formed by the plurality of image forming sections are primarily transferred; a second image forming unit that is disposed adjacent to the first image forming unit and that has a plurality of image forming sections and an intermediate transfer body to which toner images formed by the plurality of image forming sections are primarily transferred; a transport belt that transports paper to a secondary transfer position at which the toner images respectively formed on the intermediate transfer bodies of the first image forming unit and the second image forming unit are secondarily transferred; a detection device that is provided downstream of the two secondary transfer positions in a transport direction in which the paper is transported by the transport belt and that detects pattern images formed by the toner images secondarily transferred onto the transport belt; a first temperature sensor that is disposed to detect a temperature around the first image forming unit; and a second temperature sensor that is disposed to detect a temperature around the second image forming unit, in which a processor is configured to: cause all the image forming sections of the first image forming unit and the second image forming unit to form the pattern images on the transport belt in a case where a temperature difference between a temperature detected by the first temperature sensor and a temperature detected by the second temperature sensor is equal to or greater than a first threshold set in advance; and adjust a misalignment of the toner images formed by the first image forming unit and the second image forming unit by using a detection result of the detection device.

### CROSS-REFERENCE TO RELATED APPLICATIONS

This application is based on and claims priority under 35 USC 119 from Japanese Patent Application No. 2024-155452 filed Sep. 10, 2024.

### BACKGROUND

### (i) Technical Field

The present disclosure relates to an image forming apparatus, a non-transitory computer readable medium storing a program, and an image forming method.

### (ii) Related Art

JP2005-010345A discloses an image forming apparatus in which a temperature sensor is disclosed at each position of a front frame and a rear frame and that grasps a temperature rise, predicts the amount of misalignment that will occur, and performs correction.

JP2010-217544A discloses an image forming apparatus in which a temperature inside the apparatus is measured with a temperature sensor, registration adjustment is performed based on a prediction table in a case where an absolute value of the amount of change in the temperature inside the apparatus is less than a threshold, a registration adjustment patch is formed in a case where the absolute value of the amount of change in the temperature inside the apparatus is equal to or more than the threshold and a misalignment amount is actually measured, and in a case where the actually measured misalignment amount is far from a value of the prediction table, the value of the prediction table is corrected to an actually measured value.

### SUMMARY

In recent years, in order to expand a color gamut of an image formed by an image forming apparatus, an image is formed not only by toners of basic colors called CMYK but also by a toner of a spot color other than CMYK. In such an image forming apparatus, a configuration in which a toner image is formed on paper by using a plurality of image forming units each including a plurality of image forming sections that form a toner image may be used. In each image forming unit, the toner image formed by each of the plurality of image forming sections is primarily transferred onto an intermediate transfer body, and the toner image on the intermediate transfer body is secondarily transferred onto the paper transported along a paper transport path.

Components constituting each image forming unit expand due to a temperature rise inside the apparatus or contract due to a temperature drop. Therefore, a misalignment may occur at an image forming position due to a change in temperature inside the apparatus. Therefore, a temperature sensor detects a temperature change inside the image forming apparatus, pattern images for adjusting a misalignment are formed by each image forming unit in a case where the detected temperature change is large, and a detection device reads the pattern images secondarily transferred onto a transport belt to perform misalignment adjustment for adjusting a misalignment on the toner image.

Here, in a configuration in which two image forming units are disposed in the image forming apparatus, an image forming unit that is closer to a fixing device than one image forming unit in the apparatus is more likely to become hotter due to the influence of heat generated by the fixing device compared to the one image forming unit. In addition, an image forming unit that is farther from the fixing device than the other image forming unit in the apparatus is less likely to be affected by the heat generated by the fixing device compared to the other image forming unit and is often not heated to a high temperature. In a case where a temperature difference between the two image forming units increases, the difference in the amount of misalignment between the image forming positions of the toner images respectively formed by the two image forming units also increases.

Therefore, in a case where only one temperature sensor is provided in the image forming apparatus and the misalignment adjustment is performed based on only the temperature change at one location in the apparatus, the misalignment amount caused by the temperature difference between the two image forming units may be increased.

Aspects of non-limiting embodiments of the present disclosure relate to an image forming apparatus, a non-transitory computer readable medium storing a program, and an image forming method that can suppress a misalignment of image forming positions of toner images formed by two image forming units, compared to a case where a misalignment is adjusted based on a temperature at one location in an apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a first image forming unit that has a plurality of image forming sections and an intermediate transfer body to which toner images formed by the plurality of image forming sections are primarily transferred; a second image forming unit that is disposed adjacent to the first image forming unit and that has a plurality of image forming sections and an intermediate transfer body to which toner images formed by the plurality of image forming sections are primarily transferred; a transport belt that transports paper to a secondary transfer position at which the toner images respectively formed on the intermediate transfer bodies of the first image forming unit and the second image forming unit are secondarily transferred; a detection device that is provided downstream of the two secondary transfer positions in a transport direction in which the paper is transported by the transport belt and that detects pattern images formed by the toner images secondarily transferred onto the transport belt; a first temperature sensor that is disposed to detect a temperature around the first image forming unit; and a second temperature sensor that is disposed to detect a temperature around the second image forming unit, in which a processor is configured to: cause all the image forming sections of the first image forming unit and the second image forming unit to form the pattern images on the transport belt in a case where a temperature difference between a temperature detected by the first temperature sensor and a temperature detected by the second temperature sensor is equal to or greater than a first threshold set in advance; and adjust a misalignment of the toner images formed by the first image forming unit and the second image forming unit by using a detection result of the detection device.

### BRIEF DESCRIPTION OF THE DRAWINGS

Exemplary embodiment(s) of the present invention will be described in detail based on the following figures, wherein:

FIG. 1 is a schematic diagram showing a configuration of an image forming apparatus according to an exemplary embodiment of the present disclosure;

FIG. 2 is a schematic diagram showing a configuration of an image forming section according to the exemplary embodiment of the present disclosure;

FIGS. 3A to 3C are diagrams for describing pattern images for misalignment adjustment processing in the image forming apparatus according to the exemplary embodiment of the present disclosure;

FIG. 4 is a block diagram showing a control configuration of the image forming apparatus according to the exemplary embodiment of the present disclosure;

FIG. 5 is a diagram showing an example of temperatures detected by a first temperature sensor and a second temperature sensor, which are stored in a storage device of the image forming apparatus according to the exemplary embodiment of the present disclosure;

FIG. 6 is a flowchart showing an example of misalignment adjustment processing in the image forming apparatus according to the exemplary embodiment of the present disclosure; and

FIGS. 7A and 7B are diagrams showing examples of pattern images for misalignment adjustment processing in the image forming apparatus according to the exemplary embodiment of the present disclosure;

### DETAILED DESCRIPTION

Hereinafter, an exemplary embodiment of the present disclosure will be described in detail with reference to the drawings.

### Image Forming Apparatus

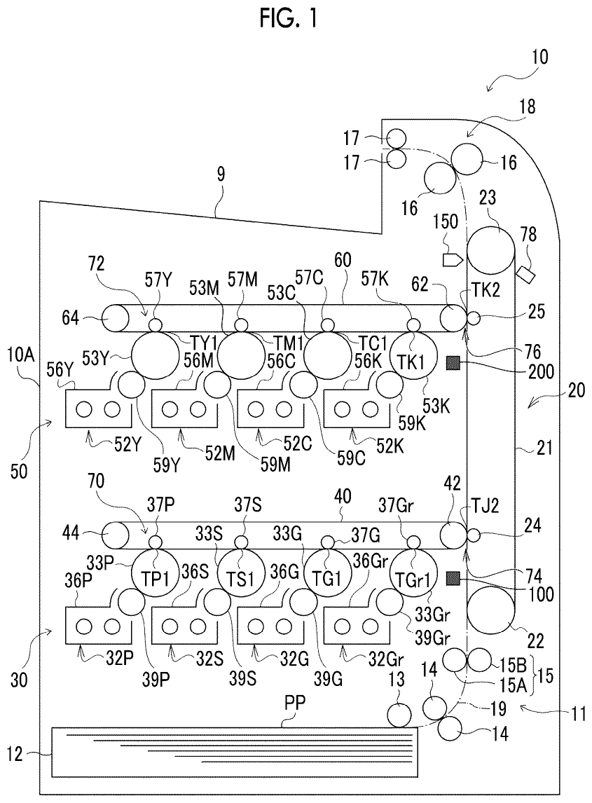

FIG. 1 is a diagram showing a configuration of an image forming apparatus 10 according to an exemplary embodiment of the present disclosure.

As shown in FIG. 1, the image forming apparatus 10 includes an accommodation section 12 that accommodates paper PP, a transport section 11 that transports the paper PP along a transport path 19, an image forming unit 30 and an image forming unit 50 that form a toner image to be transferred to the paper PP. The image forming unit 30 is used as a first image forming unit. The image forming unit 50 is used as a second image forming unit.

The accommodation section 12 can be pulled out from an image forming apparatus main body 10A that is an apparatus main body of the image forming apparatus 10, and accommodates the paper PP.

The transport section 11 includes a feed roll 13, a transport roll 14, a pair of registration rolls 15, a transport belt device 20, a fixing device 18, a discharge roll 17, and the like, in order from an upstream side in a transport direction.

The feed roll 13 feeds the paper PP accommodated in the accommodation section 12 to the transport path 19 included in the transport section 11. The transport roll 14 transports the paper PP along the transport path 19.

The pair of registration rolls 15 transport the paper PP transported by the transport roll 14 to a secondary transfer position TJ2 on a downstream side, which will be described later. The pair of registration rolls 15 sandwich the paper PP between a registration roll 15A and a pinch roll 15B, and transport the paper PP to the downstream side in the transport direction.

The transport belt device 20 transports the paper PP to the downstream side in the transport direction along the transport path 19 while transferring the toner image formed by the image forming units 30 and 50 to the paper PP. The details of the transport belt device 20 will be described later.

The fixing device 18 includes a pair of fixing rolls 16, and in a case where the paper PP passes between the pair of fixing rolls 16, the fixing device 18 applies heat and pressure to the paper PP to which the toner image is transferred, thereby fixing the toner image to the paper PP.

The discharge roll 17 discharges the paper PP on which the toner image is fixed by the fixing device 18, to a discharge section 9.

The image forming unit 30 and the image forming unit 50 are disposed adjacent to each other. In the present exemplary embodiment, the image forming unit 50 is disposed above the image forming unit 30. From another point of view, the image forming unit 50 is disposed downstream of the image forming unit 30 in the paper transport direction.

The image forming unit 30 forms a toner image of a spot color other than basic colors, for example, yellow, magenta, cyan, and black. The image forming unit 30 includes four image forming sections 32 and an intermediate transfer belt 40 as an intermediate transfer body to which toner images formed by the four image forming sections 32 are primarily transferred. The intermediate transfer belt 40 has no ends, and is mounted so as to be rotatable counterclockwise in a front view of FIG. 1 while the toner images formed by the four image forming sections 32 are transferred to the intermediate transfer belt 40.

The image forming sections 32 include an image forming section 32P that forms a toner image of spot color pink, an image forming section 32S that forms a toner image of silver, an image forming section 32G that forms a toner image of gold, and an image forming section 32Gr that forms a toner image of spot color green. The four image forming sections 32 are disposed in the order of the image forming section 32P, the image forming section 32S, the image forming section 32G, and the image forming section 32Gr in order from the upstream side (the side closer to a support roll 44 described later) in a rotation direction in which the intermediate transfer belt 40 rotates. In the following description, the upstream side in the rotation direction of the intermediate transfer belt 40 is referred to as an “upstream side in the rotation direction”, and a downstream side in the rotation direction is referred to as a “downstream side in the rotation direction”. That is, in the image forming sections 32, the image forming section 32Gr is disposed on the most downstream side in the rotation direction. In addition, in the image forming sections 32, the image forming section 32Gr is disposed at a position closest to the secondary transfer position TJ2.

In a case where it is not necessary to distinguish between P, S, G, and Gr, P, S, G, and Gr are omitted.

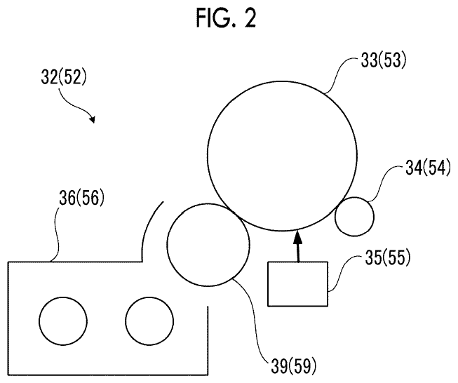

As shown in FIG. 2, the image forming section 32 includes a photoreceptor 33, a charging member 34 that charges a surface of the photoreceptor 33, an exposing device 35 that irradiates the charged photoreceptor 33 with exposure light, and a developing device 36 that develops an electrostatic latent image formed by the irradiation with the exposure light to be visualized as a toner image. The developing device 36 includes a developing roll 39, and a developing bias is applied.

In addition, primary transfer rolls 37P, 37S, 37G, and 37Gr that transfer the toner images formed by the image forming sections 32 to the intermediate transfer belt 40 are disposed at positions facing the respective photoreceptor 33 with the intermediate transfer belt 40 interposed therebetween. The intermediate transfer belt 40 is wound around the support roll 44 that supports the intermediate transfer belt 40 and a backup roll 42 disposed in a secondary transfer section 74 on the upstream side, which will be described later. A primary transfer section 70 is configured to include the photoreceptor 33, the primary transfer rolls 37, and the intermediate transfer belt 40. In addition, primary transfer positions TP1, TS1, TG1, and TGr1 are set between the photoreceptors 33P, 33S, 33G, and 33Gr, and the intermediate transfer belt 40, respectively.

The image forming unit 50 has a similar configuration to the above-described image forming unit 30 except for colors for forming an image. The image forming unit 50 forms toner images of the basic colors such as yellow, magenta, cyan, and black.

The image forming unit 50 includes four image forming sections 52 and an intermediate transfer belt 60. The intermediate transfer belt 60 is mounted so as to be rotatable counterclockwise in a front view of FIG. 1 while the toner images formed by the four image forming sections 52 are transferred to the intermediate transfer belt 60.

The image forming section 52 has a similar configuration to the image forming section 32 of the image forming unit 30 except for colors for forming an image, as shown in FIG. 2. Furthermore, the intermediate transfer belt 60 and primary transfer rolls 57 described later have similar configurations are the intermediate transfer belt 40 and the primary transfer rolls 37 of the image forming unit 30. Furthermore, the other constituent members constituting the image forming unit 50 are similar to the constituent members of the image forming unit 30.

The image forming section 52 includes an image forming section 52Y that forms a toner image of yellow, an image forming section 52M that forms a toner image of magenta, an image forming section 52C that forms a toner image of cyan, and an image forming section 52K that forms a toner image of black. The four image forming sections 52 are disposed in the order of the image forming section 52Y, the image forming section 52M, the image forming section 52C, and the image forming section 52K in order from the upstream side in the rotation direction (the side closer to a support roll 64 described later). That is, in the image forming sections 52, the image forming section 52K is disposed on the most downstream side in the rotation direction. In addition, in the image forming sections 52, the image forming section 52K is disposed at a position closest to a secondary transfer position TK2.

In a case where it is not necessary to distinguish between Y, M, C, and K, Y, M, C, and K are omitted.

The image forming section 52 includes a photoreceptor 53, a charging member 54, an exposing device 55, and a developing device 56. The developing device 56 includes a developing roll 59, and a developing bias is applied.

In addition, primary transfer rolls 57Y, 57M, 57C, and 57K are disposed at positions facing the respective photoreceptors 53 with the intermediate transfer belt 60 interposed therebetween. The intermediate transfer belt 60 is wound around the support roll 64 and a backup roll 62 disposed in a secondary transfer section 76 on the downstream side, which will be described later. A primary transfer section 72 is configured to include the photoreceptor 53, the primary transfer rolls 57, and the intermediate transfer belt 60. In addition, primary transfer positions TY1, TM1, TC1, and TK1 are set between the photoreceptors 53Y, 53M, 53C, and 53K and the intermediate transfer belt 60, respectively.

In the image forming unit 30, a first temperature sensor 100 is disposed between the image forming section 32Gr, which is closer to the secondary transfer position TJ2 than the other image forming sections 32P, 32S, and 32G, and a transport belt 21. The first temperature sensor 100 is configured to detect a temperature around the image forming unit 30. In addition, in the image forming unit 50, a second temperature sensor 200 is disposed between the image forming section 52K, which is closer to the secondary transfer position TK2 than the other image forming sections 52Y, 52M, and 52C, and the transport belt 21. The second temperature sensor 200 is configured to detect a temperature around the image forming unit 50.

Next, the transport belt device 20 will be described in detail.

As shown in FIG. 1, the transport belt device 20 includes the endless transport belt 21, support rolls 22 and 23 that support the transport belt 21, and secondary transfer rolls 24 and 25 that are disposed at positions facing the backup rolls 42 and 62 with the intermediate transfer belts 40 and 60 interposed between the backup rolls 42 and 62, and the secondary transfer rolls 24 and 25.

The transport belt 21 is configured to transport the paper to the secondary transfer positions TJ2 and TK2 at which the toner images respectively formed on the intermediate transfer belts 40 and 60 of the image forming units 30 and 50 are secondarily transferred. In addition, the transport belt 21 is configured such that when misalignment adjustment processing is performed, the toner images respectively formed on the intermediate transfer belts 40 and 60 of the image forming units 30 and 50 are secondarily transferred.

The secondary transfer roll 24 sandwiches the paper PP and the transport belt 21 between the secondary transfer roll 24 and the backup roll 42, and secondarily transfers the toner image formed on the intermediate transfer belt 40 of the image forming unit 30 to the paper PP. Similarly, the secondary transfer roll 25 sandwiches the paper PP and the transport belt 21 between the secondary transfer roll 25 and the backup roll 62, and secondarily transfers the toner image formed on the intermediate transfer belt 60 of the image forming unit 50 to the paper PP.

The secondary transfer section 74 is configured to include the backup roll 42, the secondary transfer roll 24, and the intermediate transfer belt 40. In addition, the secondary transfer section 76 is configured to include the backup roll 62, the secondary transfer roll 25, and the intermediate transfer belt 60.

A transfer bias is applied to each of the secondary transfer rolls 24 and 25.

In addition, the secondary transfer position TJ2 is defined between the intermediate transfer belt 40 of the image forming unit 30 and the transport belt 21, and the secondary transfer position TK2 is defined between the intermediate transfer belt 60 of the image forming unit 50 and the transport belt 21. The secondary transfer position TK2 is the most downstream secondary transfer position.

In addition, the transport belt device 20 includes a belt cleaning device 78 that cleans the transport belt 21. The belt cleaning device 78 performs cleaning downstream of the most downstream secondary transfer position TK2 in the paper transport direction and downstream of a detection device 150, which will be described later. In the transport belt 21, a position to be cleaned by the belt cleaning device 78 is set as a cleaning position CL.

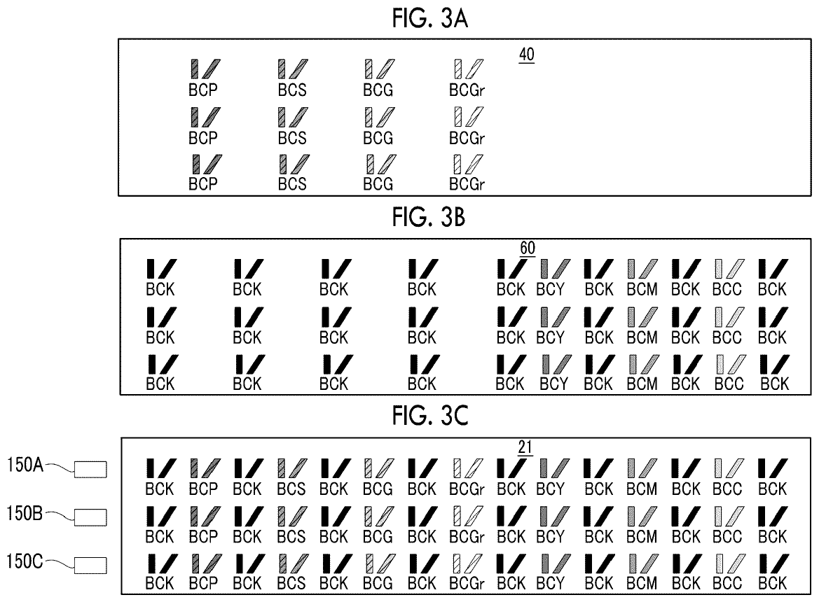

Here, as shown in FIG. 3C, each of the image forming sections 32 of the image forming unit 30 and each of the image forming sections 52 of the image forming unit 50 form pattern images BC for misalignment adjustment processing with the corresponding color toners.

The pattern images BC include toner images of eight colors: yellow (Y), magenta (M), cyan (C), black (K), spot color pink (P), silver(S), gold (G), and spot color green (Gr). In addition, reference symbols Y, M, C, K, P, S, G, and Gr written after the pattern image BC represent the colors of the toners, and are omitted in a case where it is not necessary to distinguish between the colors. The pattern images BC of each color all have the same shape, and include a horizontal line extending in a main scanning direction (up-down direction in the drawing) in the image forming units 30 and 50 and a diagonal line.

The pattern images BC have three row of patterns extending in a row in a sub-scanning direction (right-left direction in the drawing) in the image forming units 30 and 50. Patterns in each row are the same, and the pattern images BCK of black, which is a reference color, and the pattern images BC of colors other than black are alternately arranged. In addition, the pattern images are arranged at equal intervals.

In the present exemplary embodiment, the pattern images BCP, BCS, BCG, and BCGr for the misalignment adjustment processing are formed on the intermediate transfer belt 40. In addition, the pattern images BCY, BCM, BCC, and BCK for the misalignment adjustment processing are formed on the intermediate transfer belt 60. Then, each of the pattern images BCP, BCS, BCG, BCGr, BCY, BCM, BCC, and BCK is secondarily transferred to the transport belt 21.

As shown in FIG. 1, the detection device 150 is provided in the vicinity of an upper end portion of the transport belt 21. In addition, the detection device 150 is provided downstream of the secondary transfer positions TJ2 and TK2 in the transport direction in which the paper PP is transported by the transport belt 21. Furthermore, the detection device 150 is provided downstream of the most downstream secondary transfer position TK2 in the paper transport direction and upstream of the belt cleaning device 78 in the paper transport direction.

The detection device 150 is configured to detect the pattern image BC formed by the toner image that is secondarily transferred to the transport belt 21 downstream of the secondary transfer position TK2 in the paper transport direction and upstream of the cleaning position CL in the paper transport direction.

In other words, the detection device 150 is disposed at a position where the pattern image BC can be detected downstream of the most downstream secondary transfer section 76 in the paper transport direction. In other words, the detection device 150 is disposed at a position where all the pattern images BC formed by all the image forming sections 32P, 32S, 32G, 32Gr, 52Y, 52M, 52C, and 52K can be detected.

The detection device 150 of the present exemplary embodiment includes three detection units 150A, 150B, and 150C arranged at intervals in an axial direction, in other words, in a width direction (paper width direction, also referred to as the main scanning direction) of the transport belt 21 (see FIG. 3C). The pattern images BC are formed in three rows corresponding to positions of the detection units 150A, 150B, and 150C.

As described above, by using the three rows of the pattern images BC extending in the sub-scanning direction, it is possible to independently adjust the misalignment at three places (for example, both end portions and a center portion) in the main scanning direction.

The pattern images BC for the misalignment adjustment processing are formed as follows. First, as shown in FIG. 3A, the pattern images BCP, BCS, BCG, and BCGr are primarily transferred to the intermediate transfer belt 40 by the image forming unit 30.

In addition, as shown in FIG. 3B, a plurality of the pattern images BCK of the reference color are primarily transferred to the intermediate transfer belt 60 by the image forming unit 50 such that the pattern images BCP, BCS, BCG, and BCGr are disposed between the plurality of pattern images BCK during the secondary transfer to the transport belt 21, and furthermore, the pattern images BCY, BCM, and BCC are primarily transferred to the intermediate transfer belt 60 such that the pattern images BCY, BCM, and BCC are disposed between the plurality of pattern images BCK.

Finally, as shown in FIG. 3C, the pattern images BC primarily transferred to the intermediate transfer belts 40 and 60 are secondarily transferred to the transport belt 21, and becomes the pattern images BC for the misalignment adjustment processing. That is, the pattern images BC of the other colors are formed between the plurality of pattern images BCK of a predetermined reference color, for example, black. As described above, by using the pattern images BCK of black as the reference color having the lowest reflectance, which are closest to the most downstream secondary transfer position TK2, the accuracy of the adjustment of misalignment can be improved.

### Control Device

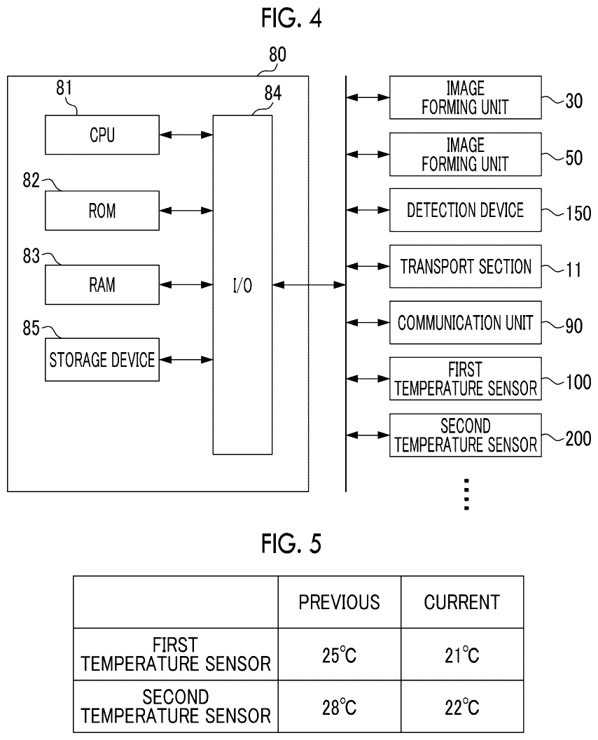

Next, a control device 80 that controls an operation of the image forming apparatus 10 will be described with reference to FIG. 4.

As shown in FIG. 4, the image forming unit 30, the image forming unit 50, the detection device 150, the transport section 11, a communication unit 90, the first temperature sensor 100, the second temperature sensor 200, and the like are electrically connected to the control device 80.

As shown in FIG. 4, the control device 80 includes a central processing unit (CPU) 81, a read only memory (ROM) 82, a random access memory (RAM) 83, a storage device 85 such as a hard disk drive, and an input/output interface (abbreviated as I/O) 84 that inputs and outputs data to and from each device via a network. These components are connected to each other via a control bus.

Here, the ROM 82 stores an image formation control program (not shown) to be executed by the CPU 81. Then, the CPU 81 reads the image formation control program (not shown) from the ROM 82 and expands the image formation control program into the RAM 83 to execute a printing process according to the image formation control program (not shown).

In addition, the image forming unit 30, the image forming unit 50, the detection device 150, the transport section 11, the communication unit 90, the first temperature sensor 100, the second temperature sensor 200, and the like are connected to the I/O 84. The communication unit 90 is an interface for performing data communication between a terminal device such as a personal computer and the image forming apparatus 10.

The storage device 85 stores installation positions of the image forming sections 32 and 52 of the respective colors in the image forming units 30 and 50. In addition, in a case where the misalignment adjustment processing is performed, the storage device 85 stores a misalignment amount and correction amount in a case where the adjustment processing is performed. In addition, as shown in FIG. 5, in a case where the misalignment adjustment processing is performed, the storage device 85 stores the temperatures detected by the first temperature sensor 100 and the second temperature sensor 200 in a case where the misalignment adjustment processing is performed (previous temperatures) and the temperatures detected by the first temperature sensor 100 and the second temperature sensor 200 at the time of power-on or the start of printing (current temperatures). The storage device 85 is used as a memory.

The control device 80 performs various controls for forming the toner image on the intermediate transfer belts 40 and 60 by the image forming sections 32 and 52 of the respective colors of the image forming units 30 and 50.

In addition, the control device 80 controls developing biases applied to the developing rolls 39 and 59 of the developing devices 36 and 56, respectively. Furthermore, the control device 80 controls transfer biases applied to the secondary transfer rolls 24 and 25, respectively.

In addition, the control device 80 controls a supply timing, a supply time, a supply amount, and the like of toner supply of each color toner from a toner cartridge of each color to the developing devices 36 and 56.

In addition, the control device 80 calculates a temperature difference between the temperature detected by the first temperature sensor 100 and the temperature detected by the second temperature sensor 200. Then, the control device 80 causes the image forming sections of the respective colors of the image forming unit 30 and/or the image forming unit 50 to form pattern images on the transport belt 21 according to the calculated temperature difference.

Here, “A and/or B” is synonymous with “at least one of A or B”. That is, “A and/or B” means that A alone may be used, B alone may be used, or a combination of A and B may be used.

In addition, the control device 80 calculates a temperature difference between a temperature detected by the first temperature sensor 100 in a case where previous misalignment is adjusted, which is stored in the storage device 85, and a temperature detected by the first temperature sensor 100 at the current power-on or start of printing. In addition, the control device 80 calculates a temperature difference between a temperature detected by the second temperature sensor 200 in a case where the previous misalignment is adjusted, which is stored in the storage device 85, and a temperature detected by the second temperature sensor 200 at the current power-on or start of printing. Then, the control device 80 forms pattern images on the transport belt 21 by the image forming sections of the respective colors of the image forming unit 30 and/or the image forming unit 50 according to the calculated temperature difference.

The control device 80 causes the detection device 150 to detect the pattern images BC. The control device 80 controls a timing of forming the toner image on the intermediate transfer belts 40 and 60, specifically, an exposure timing of each of the exposing device 35 and 55, and controls the developing bias applied to each of the developing rolls 39 and 59, and the transfer bias applied to the secondary transfer rolls 24 and 25, based on a detection result. That is, the misalignment adjustment processing of the toner image formed by the image forming unit 30 and the image forming unit 50 is performed by using the detection result of the detection device 150.

The control device 80 causes the storage device 85 to store the temperature detected by the first temperature sensor 100 in a case where the misalignment adjustment processing is performed and the temperature detected by the second temperature sensor 200.

### Image Forming Process

Next, an outline of an image forming process in the image forming apparatus 10 will be described.

First, the control device 80 controls each image forming section 32 such that a toner image is formed on the intermediate transfer belt 40 of the image forming unit 30. Similarly, the control device 80 controls each image forming section 52 such that a toner image is formed on the intermediate transfer belt 60 of the image forming unit 50.

Specifically, the control device 80 applies a voltage to the charging members 34 and 54, and the charging members 34 and 54 to which the voltage is applied charge the surfaces of the photoreceptors 33 and 53 to a predetermined potential. Subsequently, the control device 80 causes the exposing devices 35 and 55 to irradiate the surfaces of the photoreceptors 33 and 53 charged by the charging members 34 and 54 with exposure light to form an electrostatic latent image, based on image data acquired through the communication unit 90. As a result, the electrostatic latent image corresponding to the image data is formed on the surfaces of the photoreceptors 33 and 53.

Next, the control device 80 causes the developing devices 36 and 56 to develop the electrostatic latent image formed by the exposing devices 35 and 55 and visualizes the electrostatic latent image as a toner image. Furthermore, the control device 80 causes the primary transfer rolls 37 and 57 to superimpose and transfer the toner images formed on the surfaces of the photoreceptors 33 and 53 of the respective colors on the intermediate transfer belts 40 and 60.

In this way, by the image forming unit 30, for example, a toner image, in which toners of spot color pink (P), silver(S), gold (G), and spot color green (Gr) are superimposed, is formed on the intermediate transfer belt 40. Similarly, by the image forming unit 50, for example, a toner image, in which toners of yellow (Y), magenta (M), cyan (C), and black (K) are superimposed, is formed on the intermediate transfer belt 60.

Here, the paper PP fed from the accommodation section 12 to the transport path 19 by the feed roll 13 is fed to the secondary transfer position TJ2 after a transport timing is adjusted by the pair of registration rolls 15 based on the control of the control device 80. At the secondary transfer position TJ2, the paper PP is transported between the backup roll 42 and the secondary transfer roll 24, so that the toner image on an outer peripheral surface of the intermediate transfer belt 40 is transferred to the paper PP. Then, the paper PP on which the toner image is transferred is transported to the downstream side in the transport direction and reaches the secondary transfer position TK2 on the downstream side in the transport direction.

At this time, the control device 80 adjusts the timing to start image formation such that the toner image formed on the intermediate transfer belt 60 of the image forming unit 50 is superimposed and transferred onto the toner image on the paper PP transported from the upstream side in the transport direction.

The paper PP on which the toner images of the respective colors formed by the image forming units 30 and 50 are superimposed and transferred is fixed by the pair of fixing rolls 16 of the fixing device 18 and then discharged to the discharge section 9 provided on an upper portion of the image forming apparatus main body 10A by the discharge roll 17.

### Misalignment Adjustment Processing

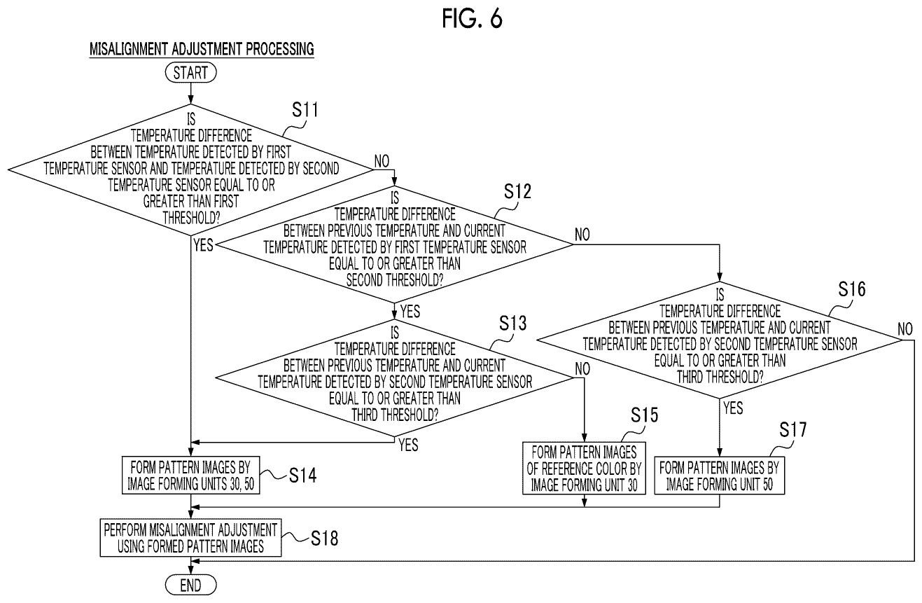

Next, an example of the misalignment adjustment processing in the image forming apparatus 10 will be described with reference to FIG. 6.

First, in step S11, the control device 80 determines whether or not the temperature difference between the temperature detected by the first temperature sensor 100 and the temperature detected by the second temperature sensor 200 is equal to or greater than a first threshold set in advance (for example, equal to or greater than 5° C.) at the time power-on of the image forming apparatus 10 or the start of printing. In a case where the temperature difference between the temperature detected by the first temperature sensor 100 and the temperature detected by the second temperature sensor 200 is equal to or greater than the first threshold, the processing proceeds to a process of step S14, and in a case where the temperature difference is less than the first threshold, the processing proceeds to a process of step S12.

In step S12, in a case where the temperature difference between the temperature detected by the first temperature sensor 100 and the temperature detected by the second temperature sensor 200 is less than the first threshold, the control device 80 determines whether or not a temperature difference between a detection temperature detected by the first temperature sensor 100 in a case where previous misalignment adjustment processing is performed, which is stored in the storage device 85, and a detection temperature detected by the first temperature sensor 100 at the current power-on or start of printing is equal to or greater than a second threshold set in advance (for example, equal to or greater than 5° C.). In a case where the temperature difference between the detection temperature detected by the first temperature sensor 100 in a case where the previous misalignment adjustment processing is performed and the detection temperature detected by the first temperature sensor 100 at the current power-on or start of printing is equal to or greater than a second threshold set in advance, the processing proceeds to a process of step S13, and in a case where the temperature difference is less than the second threshold, the processing proceeds to a process of step S16.

In step S13, in a case where the temperature difference between the detection temperature detected by the first temperature sensor 100 in a case where the previous misalignment adjustment processing is performed, which is stored in the storage device 85, and the detection temperature detected by the first temperature sensor 100 at the current power-on or start of printing is equal to or greater than the second threshold, the control device 80 determines whether or not a temperature difference between a detection temperature detected by the second temperature sensor 200 in a case where the previous misalignment adjustment processing is performed, which is stored in the storage device 85, and a detection temperature detected by the second temperature sensor 200 at the current power-on or start of printing is equal to or greater than a third threshold set in advance (for example, equal to or greater than 5° C.). In a case where the temperature difference between the detection temperature detected by the second temperature sensor 200 in a case where the previous misalignment adjustment processing is performed and the detection temperature detected by the second temperature sensor 200 at the current power-on or start of printing is equal to or greater than the third threshold set in advance, the processing proceeds to the process of step S14, and in a case where the temperature difference is less than the third threshold, the processing proceeds to a process of step S15.

In step S14, the control device 80 causes all the image forming sections 32 and 52 of the image forming unit 30 and the image forming unit 50 to form the pattern images BC on the transport belt 21. That is, the toner images are primarily transferred onto the intermediate transfer belt 40 by using the image forming sections 32P, 32S, 32G, and 32Gr of the image forming unit 30. In addition, the toner images are primarily transferred onto the intermediate transfer belt 60 by using the image forming sections 52Y, 52M, 52C, and 52K of the image forming unit 50. Then, the toner images primarily transferred onto the intermediate transfer belts 40 and 60 are secondarily transferred onto the transport belt 21 to form the pattern images BC. At this time, as shown in FIG. 3C, the pattern images BCK of black, which is the reference color, are formed between the pattern images BCP, BCS, BCG, BCGr, BCY, BCM, and BCC.

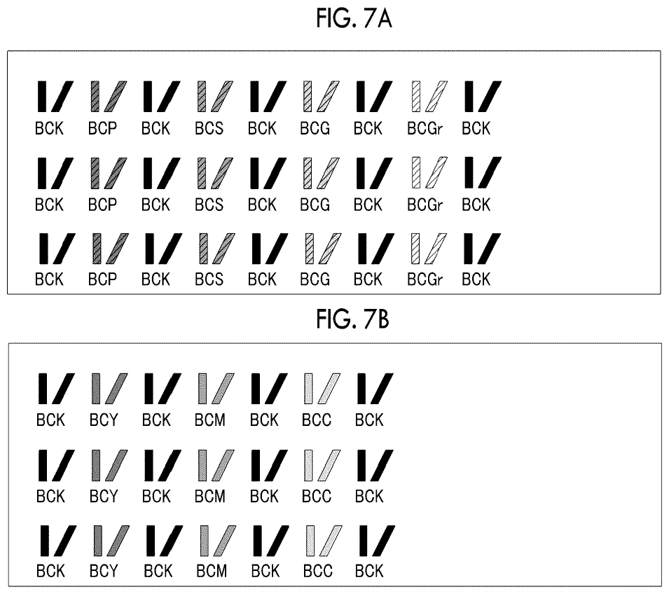

In step S15, in a case where the temperature difference between the detection temperature detected by the second temperature sensor 200 in a case where the previous misalignment adjustment processing is performed, which is stored in the storage device 85, and the detection temperature detected by the second temperature sensor 200 at the current power-on or start of printing is less than a third threshold, the toner images are primarily transferred onto the intermediate transfer belt 40 by the image forming sections 32P, 32S, 32G, and 32Gr of the image forming unit 30, and the toner image is primarily transferred onto the intermediate transfer belt 60 by the image forming section 52K of the image forming unit 50 corresponding to the reference color. Then, the toner images primarily transferred onto the intermediate transfer belts 40 and 60 are secondarily transferred onto the transport belt 21 to form the pattern images BC. At this time, as shown in FIG. 7A, the pattern images BCK of black, which is the reference color, are formed between the pattern images BCP, BCS, BCG, and BCGr. At this time, any of the image forming sections 32 of the image forming unit 30 may be used as the reference color. For example, in a case where the spot color green is used as the reference color, the pattern images BCGr of the spot color green, which is the reference color, are formed between the pattern images BCP, BCS, and BCG using only the image forming unit 30.

In step S16, in a case where the temperature difference between the temperature detected by the first temperature sensor 100 in a case where the previous misalignment adjustment processing is performed, which is stored in the storage device 85, and the temperature detected by the first temperature sensor 100 at the current power-on or start of printing is less than the second threshold set in advance, the control device 80 determines whether or not the temperature difference between the detection temperature detected by the second temperature sensor 200 in a case where the previous misalignment adjustment processing is performed, which is stored in the storage device 85, and the detection temperature detected by the second temperature sensor 200 at the current power-on or start of printing is equal to or greater than the third threshold set in advance. In a case where the temperature difference between the detection temperature detected by the second temperature sensor 200 in a case where the previous misalignment adjustment processing is performed and the detection temperature detected by the second temperature sensor 200 at the current power-on or start of printing is equal to or greater than the third threshold set in advance, the processing proceeds to a process of step S17, and in a case where the temperature difference is less than the third threshold, the processing ends without performing the misalignment adjustment processing.

In step S17, in a case where the temperature difference between the detection temperature detected by the second temperature sensor 200 in a case where the previous misalignment adjustment processing is performed, which is stored in the storage device 85, and the detection temperature detected by the second temperature sensor 200 at the current power-on or start of printing is equal to or greater than the third threshold, the control device 80 uses the image forming sections 52Y, 52M, 52C, and 52K of the image forming unit 50 to primarily transfer the toner images onto the intermediate transfer belt 60, and then secondarily transfer the toner images primarily transferred onto the intermediate transfer belt 60 onto the transport belt 21 to form the pattern images BC. At this time, as shown in FIG. 7B, the pattern images BCK of black, which is the reference color, are formed between the pattern images BCY, BCM, and BCC.

Specifically, for example, in a case where the temperature detected by the first temperature sensor 100 at the current power-on or start of printing is 21° C. and the temperature detected by the second temperature sensor 200 is 22° C., the control device 80 sets the temperature difference between the temperatures to 1° C. That is, in a case where the first threshold is set to 5° C., the temperature difference between the temperature detected by the first temperature sensor 100 and the temperature detected by the second temperature sensor 200 is less than the first threshold.

In a case where the temperature detected by the first temperature sensor 100 in a case where the previous misalignment adjustment processing is performed, which is stored in the storage device 85, is 25° C. and the temperature detected by the first temperature sensor 100 at the current power-on or start of printing is 21° C., the control device 80 sets the temperature difference between the temperatures to 4° C. That is, in a case where the second threshold is set to 5° C., the temperature difference between the temperatures detected by the first temperature sensor 100 at the previous time and at the current time is less than the second threshold.

In addition, in a case where the temperature detected by the second temperature sensor 200 in a case where the previous misalignment adjustment processing is performed, which is stored in the storage device 85, is 28° C. and the temperature detected by the second temperature sensor 200 at the current power-on or start of printing is 22° C., the control device 80 sets the temperature difference between the temperatures to 6° C. That is, in a case where the third threshold is set to 5° C., the temperature difference between the temperatures detected by the second temperature sensor 200 at the previous time and at the current time is equal to or greater than the third threshold.

In this case, the control device 80 uses the image forming sections 52Y, 52M, 52C, and 52K in the image forming unit 50 in which the temperature difference is equal to or greater than the third threshold to primarily transfer the toner images onto the intermediate transfer belt 60, and then secondarily transfer the toner images primarily transferred onto the intermediate transfer belt 60 onto the transport belt 21 to form the pattern images BC.

In step S18, the control device 80 performs the misalignment adjustment processing using the formed pattern images BC. Specifically, the control device 80 detects the formed pattern images BC using the detection device 150, and performs the misalignment adjustment processing based on the detection result of the detection device 150.

Here, in a case of performing the misalignment adjustment processing between the colors, the misalignment amount of the pattern image BC of colors other than black is acquired based on the pattern image BCK of black, which is the reference color. Then, a correction value is calculated from the misalignment amount with the pattern image BCK, and the exposure timing of the exposure devices 35P, 35S, 35G, 35Gr, 55Y, 55M, 55C, and 55K is adjusted.

That is, the control device 80 adjusts the misalignment such that the pattern images BCP, BCS, BCG, and BCGr of the image forming unit 30 are at predetermined positions and have predetermined positional relationships with the pattern images BCK. Similarly, the control device 80 adjusts the misalignment such that the pattern images BCY, BCM, and BCC of the other colors of the image forming unit 50 are at predetermined positions and have predetermined positional relationships with the pattern images BCK.

As described above, the temperature sensors are respectively disposed around the image forming units 30 and 50 adjacent to each other, and the pattern images BC are formed by the image forming sections 32 and/or the image forming sections 52 according to the temperature difference between the image forming units 30 and 50 or the temperature difference between the temperatures during the previous misalignment adjustment processing to perform the misalignment adjustment processing. Accordingly, the misalignment amount caused by the temperature difference between the two image forming units 30 and 50 can be reduced.

Furthermore, compared to a case where the pattern images BC of all colors are always formed by all the image forming sections 32 and 52 and the misalignment adjustment processing is performed, a reading time can be shortened, and as a result, a misalignment adjustment time can be shortened, thereby improving adjustment efficiency. In addition, compared to the case of forming the pattern images BC of all colors, the amount of toner consumed in the misalignment adjustment processing can be reduced.

The misalignment adjustment processing is not limited to the above-described aspect and may be performed by any method.

In addition, in the present exemplary embodiment, since the detection device 150 detects the pattern images BC that are secondarily transferred to the transport belt 21, detection accuracy is improved compared a case where the pattern images BC that are secondarily transferred to the paper PP that differs in surface condition depending on the material or the like are detected.

### Other Forms

The present disclosure is not limited to the above-described exemplary embodiment.

For example, in the above-described exemplary embodiment, the configuration in which the image forming unit 50 is disposed above the image forming unit 30 has been described, but the present disclosure is not limited thereto. The image forming unit 30 and the image forming unit 50 may be arranged to be adjacent to each other in a horizontal direction.

In addition, in the above-described exemplary embodiment, the first temperature sensor 100 and the second temperature sensor 200 are provided around the image forming sections 32Gr and 52K close to the secondary transfer positions TJ2 and TK2 of the respective image forming units, but the present disclosure is not limited thereto. The first temperature sensor 100 and the second temperature sensor 200 may be provided at positions where the temperatures around the image forming units 30 and 50 can be detected.

In addition, in the above-described exemplary embodiment, the detection device 150 that detects the pattern images BC secondarily transferred to the transport belt 21 is provided downstream of a plurality of secondary transfer positions TJ2 and TK2, but the present disclosure is not limited thereto. The detection device 150 may be provided at other places.

Furthermore, a detection device that detects the pattern images BC between the most downstream primary transfer positions TGr1 and TK1 and the secondary transfer positions TJ2 and TK2 in the intermediate transfer belts 40 and 60 may be further provided.

Furthermore, in the above-described exemplary embodiment, a case where the pattern image BCK of black as the reference color is used in a case where the misalignment adjustment processing is performed has been described, but the present disclosure is not limited thereto. Another color may be used as the reference color.

In addition, the image forming section of the cheapest color may be used as the reference color in each of the image forming units 30 and 50. Accordingly, the consumption of the toner of expensive colors can be reduced.

In addition, in the above-described exemplary embodiment, the misalignment amount may be detected by forming the pattern images BC for each of the image forming units 30 and 50 without using the reference color.

Furthermore, in the above-described exemplary embodiment, the case where the misalignment adjustment processing is performed by using the pattern image BC has been described, but the present disclosure is not limited thereto. Color adjustment such as density adjustment processing other than the misalignment adjustment processing may be performed.

In addition, in the above-described exemplary embodiment, the detection device 150 is configured to detect the pattern images BC that are secondarily transferred to the transport belt 21, but the present disclosure is not limited thereto. The detection device 150 may be configured to detect the pattern images BC secondarily transferred to the paper PP.

Furthermore, the configuration of the image forming apparatus is not limited to the configuration of the above-described exemplary embodiment, and various configurations can be used. Further, the present invention can be implemented in various ways without departing from the concept of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The technology of the present disclosure can also be applied to a program and a program product.

### Supplementary Note

Hereinafter, the forms of the present disclosure will be described.

(((1)))

An image forming apparatus comprising:
a first image forming unit that has a plurality of image forming sections and an intermediate transfer body to which toner images formed by the plurality of image forming sections are primarily transferred;
a second image forming unit that is disposed adjacent to the first image forming unit and that has a plurality of image forming sections and an intermediate transfer body to which toner images formed by the plurality of image forming sections are primarily transferred;
a transport belt that transports paper to a secondary transfer position at which the toner images respectively formed on the intermediate transfer bodies of the first image forming unit and the second image forming unit are secondarily transferred;
a detection device that is provided downstream of the two secondary transfer positions in a transport direction in which the paper is transported by the transport belt and that detects pattern images formed by the toner images secondarily transferred onto the transport belt;
a first temperature sensor that is disposed to detect a temperature around the first image forming unit;
a second temperature sensor that is disposed to detect a temperature around the second image forming unit;
a processor,
wherein the processor is configured to:
   cause all the image forming sections of the first image forming unit and the second image forming unit to form the pattern images on the transport belt in a case where a temperature difference between a temperature detected by the first temperature sensor and a temperature detected by the second temperature sensor is equal to or greater than a first threshold set in advance; and
   adjust a misalignment of the toner images formed by the first image forming unit and the second image forming unit by using a detection result of the detection device.
      (((2)))

The image forming apparatus according to (((1))), further comprising:
a memory,
wherein the memory stores temperatures respectively detected by the first temperature sensor and the second temperature sensor in a case where a previous misalignment is adjusted, and
the processor is configured to:
   cause, even in a case where the temperature difference between the temperature detected by the first temperature sensor and the temperature detected by the second temperature sensor is less than the first threshold, the plurality of image forming sections of the first image forming unit to form the pattern images on the transport belt in a case where a temperature difference between the temperature detected by the first temperature sensor in a case where the precious misalignment is adjusted, which is stored in the memory, and a temperature detected by the first temperature sensor at a current time is equal to or greater than a second threshold set in advance; and
   adjust the misalignment of the toner image formed by the first image forming unit by using the detection result of the detection device.
      (((3)))

The image forming apparatus according to (((2))), wherein the processor is configured to:
cause, in a case where a temperature difference between a temperature detected by the second temperature sensor in a case where the previous misalignment is adjusted, which is stored in the memory, and a temperature detected by the second temperature sensor at a current time is equal to or greater than a third threshold set in advance, the plurality of image forming sections of the second image forming unit to form the pattern images on the transport belt; and
adjust the misalignment of the toner image formed by the second image forming unit by using the detection result of the detection device.
   (((4)))

The image forming apparatus according to (((1))), wherein the processor is configured to: cause all the image forming sections of the first image forming unit and the second image forming unit to form, in a case where the pattern images are formed on the transport belt, pattern images of the other colors between pattern images of a predetermined reference color in the second image forming unit.

(((5)))

The image forming apparatus according to (((4))), wherein the image forming section used as the reference color is the image forming section closest to the secondary transfer position.

(((6))) The image forming apparatus according to (((4))), wherein the reference color is black.
(((7)))

A program causing a computer to execute:
causing, in a case where a temperature difference between a temperature detected by a first temperature sensor disposed to detect a temperature around a first image forming unit and a temperature detected by a second temperature sensor disposed to detect a temperature around a second image forming unit disposed adjacent to the first image forming unit is equal to or greater than a first threshold set in advance, all image forming sections of the first image forming unit and the second image forming unit to form pattern images on a transport belt; and
adjusting a misalignment of the toner images formed by the first image forming unit and the second image forming unit by using a detection result of a detection device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first image forming unit that has a plurality of image forming sections and an intermediate transfer body to which toner images formed by the plurality of image forming sections are primarily transferred;
a second image forming unit that is disposed adjacent to the first image forming unit and that has a plurality of image forming sections and an intermediate transfer body to which toner images formed by the plurality of image forming sections are primarily transferred;
a transport belt that transports paper to a secondary transfer position at which the toner images respectively formed on the intermediate transfer bodies of the first image forming unit and the second image forming unit are secondarily transferred;
a detection device that is provided downstream of the two secondary transfer positions in a transport direction in which the paper is transported by the transport belt and that detects pattern images formed by the toner images secondarily transferred onto the transport belt;
a first temperature sensor that is disposed to detect a temperature around the first image forming unit;
a second temperature sensor that is disposed to detect a temperature around the second image forming unit; and
a processor,
wherein the processor is configured to:
cause all the image forming sections of the first image forming unit and the second image forming unit to form the pattern images on the transport belt in a case where a temperature difference between a temperature detected by the first temperature sensor and a temperature detected by the second temperature sensor is equal to or greater than a first threshold set in advance; and
adjust a misalignment of the toner images formed by the first image forming unit and the second image forming unit by using a detection result of the detection device.

2. The image forming apparatus according to claim 1, further comprising:
a memory,
wherein the memory stores temperatures respectively detected by the first temperature sensor and the second temperature sensor in a case where a previous misalignment is adjusted, and
the processor is configured to:
cause, even in a case where the temperature difference between the temperature detected by the first temperature sensor and the temperature detected by the second temperature sensor is less than the first threshold, the plurality of image forming sections of the first image forming unit to form the pattern images on the transport belt in a case where a temperature difference between the temperature detected by the first temperature sensor in a case where the previous misalignment is adjusted, which is stored in the memory, and a temperature detected by the first temperature sensor at a current time is equal to or greater than a second threshold set in advance; and
adjust the misalignment of the toner image formed by the first image forming unit by using the detection result of the detection device.

3. The image forming apparatus according to claim 2, wherein the processor is configured to:
cause, in a case where a temperature difference between a temperature detected by the second temperature sensor in a case where the previous misalignment is adjusted, which is stored in the memory, and a temperature detected by the second temperature sensor at a current time is equal to or greater than a third threshold set in advance, the plurality of image forming sections of the second image forming unit to form the pattern images on the transport belt; and
adjust the misalignment of the toner image formed by the second image forming unit by using the detection result of the detection device.

4. The image forming apparatus according to claim 1, wherein the processor is configured to:
cause all the image forming sections of the first image forming unit and the second image forming unit to form, in a case where the pattern images are formed on the transport belt, pattern images of the other colors between pattern images of a predetermined reference color in the second image forming unit.

5. The image forming apparatus according to claim 4,
wherein the image forming section used as the reference color is the image forming section closest to the secondary transfer position.

6. The image forming apparatus according to claim 4, wherein the reference color is black.

7. A non-transitory computer readable medium storing a program causing a computer to execute:
causing, in a case where a temperature difference between a temperature detected by a first temperature sensor disposed to detect a temperature around a first image forming unit and a temperature detected by a second temperature sensor disposed to detect a temperature around a second image forming unit disposed adjacent to the first image forming unit is equal to or greater than a first threshold set in advance, all image forming sections of the first image forming unit and the second image forming unit to form pattern images on a transport belt; and
adjusting a misalignment of the toner images formed by the first image forming unit and the second image forming unit by using a detection result of a detection device.

8. An image forming method comprising:
causing, in a case where a temperature difference between a temperature detected by a first temperature sensor disposed to detect a temperature around a first image forming unit and a temperature detected by a second temperature sensor disposed to detect a temperature around a second image forming unit disposed adjacent to the first image forming unit is equal to or greater than a first threshold set in advance, all image forming sections of the first image forming unit and the second image forming unit to form pattern images on a transport belt; and
adjusting a misalignment of the toner images formed by the first image forming unit and the second image forming unit by using a detection result of a detection device.
